(19) United States
(12) Patent Application Publication
(10) Pub. No.: US 2009/0315992 A1
(43) Pub. Date: Dec. 24, 2009

(54) Image Capturing Device for a Driver Assistance System

(76) Inventor: Karsten Haug, Stuttgart (DE)

Correspondence Address: KENYON & KENYON LLP, ONE BROADWAY, NEW YORK, NY, 10004, US

(21) Appl. No.: 12/223,486

(22) PCT Filed: Jan. 11, 2007
(86) PCT No.: PCT/EP2007/050259

§ 371 Date: Dec. 11, 2008

(30) Foreign Application Priority Data
Feb. 17, 2006 (DE) 10 2006 007 343.6

(51) Int. Cl. H04N 7/18

(52) U.S. Cl. 348/148; 455/556.1; 348/E07.085

(57) ABSTRACT

An image capturing device for a driver assistance system having a mobile communication device includes an image sensor and a holding device for holding the mobile communication device in a vehicle. The holding device includes a device adapter for accommodating the communication device, a vehicle adapter disposed in a manner that is fixed to the vehicle, and a universal module that is disposed between the vehicle adapter and the device adapter.

### BACKGROUND OF THE INVENTION

1. Field of the Invention

The present invention relates to an image capturing device for a driver assistance system.

2. Description of Related Art

From published German patent document DE 102 01 612, an arrangement for handling a communication device is known, which is made up of a universally usable, non-mobile-phone-specific mounting device and of a mobile-phone-specific device holder that produce the complete arrangement in the assembled state. In this instance, the device holder contains the required mechanical and electric or electronic adjustments to the communication device that is respectively to be used. The arrangement is provided in particular for the integration of mobile phones of various types in a vehicle. While with this known arrangement it would seem possible to operate mobile phones of various designs and of various manufacturers in a manner that is fixed to the vehicle, an integration of mobile communication devices having an image sensor that are supposed to interact with a driver assistance system is not readily possible.

### A BRIEF SUMMARY OF THE INVENTION

The present invention aims to further improve an image capturing device with a mobile communication device in order to be able to use this device as a component of a driver assistance system. This makes it possible to use a mobile communication device having an image sensor, often referred to as a “camera phone” in conventional usage, as an image sensor of a driver assistance system. This is achieved through a vehicle-specific vehicle adapter that is disposed in a manner that is fixed to the vehicle. This vehicle adapter makes it possible to accommodate a device-specific device adapter, which for its part is used as a holding device for the mobile communication device, when a universal module is interposed. In this way, a universal usability of the mobile communication device is ensured. The communication device is integrated into the vehicle with the help of the above-mentioned adapters and of the universal module. It thus becomes, at least temporarily, a component part of the vehicle and may interact with its systems. In particular, it is a component part of a driver assistance system and is able to advantageously capture video data from the vehicle surroundings using its image-sensor function.

If the mobile communication device is mounted via the function module and the adapter with a forward direction of view, the image sensor may advantageously detect road markings and thus enable a lateral guidance of the vehicle, for example. An installation having a backward or lateral direction of view is equally possible. After the mobile communication device has been taken out of the vehicle, the communication device may be operated as an autonomous, mobile communication device in accordance with its original purpose.

The use of the mobile communication device in a manner that is fixed to the vehicle requires that it occupies an exactly defined installation position after integration into the vehicle, to ensure that the image sensor of the communication device covers the predetermined detecting range. This is advantageously enabled by a corresponding fixing of the holding device. The holding device is advantageously disposed at the level of the interior mirror on the windshield to enable a good visual range for the image sensor of the communication device. Through the constructively specified position of the adapter of the holding device, a calibration of the arrangement may advantageously prove superfluous since after inserting the communication device into the holding device the image sensor of the communication device already assumes its setpoint position without additional adjustment.

The exact mounting position of the holding device is advantageously coded and stored in the holding device in the form of data. These data may be called up via a bus system of the vehicle which integrates the holding device into the system structure of the vehicle. The driver assistance system may thus call up the coordinates of the mounting location of the holding device and advantageously transform these into a central coordinate system of the vehicle. This is necessary for the LDW (Lane Departure Warning) driver assistance function of the driver assistance system, for example.

The holding device advantageously includes a baffle that keeps disturbing stray light away from the image sensor of the communication device. Furthermore, the holding device advantageously includes a function module or possibly several function modules that enable a heating and/or a cooling of the communication device to keep it at an operating temperature that is as constant as possible. This is advantageous in terms of a high operational reliability since the communication device is subjected to strong temperature fluctuations at its exposed installation position behind the windshield of the vehicle. This is also useful since communication devices for use in the consumer area are able to function only in a relatively narrow temperature range. However, for a vehicle-specific application a wider temperature range is to be allowed for. The above-mentioned measure increases the availability. Damages resulting from a strong temperature stress are able to be avoided.

Very comfortable driver assistance systems make it possible to adapt specific parameters in a driver-specific manner, within certain limits. Thus, for example, in connection with the LDW function it is possible to specify whether a corresponding warning is to occur temporally early, later, or adaptively, as a function of speed, for example. It is advantageously provided that these driver-specific specifications be stored in the device adapter. They are then once more readily available to the driver in the event of a necessary vehicle change if he inserts his mobile communication device together with the device adapter into the holding device of another vehicle.

### A BRIEF DESCRIPTION OF THE SEVERAL VIEWS OF THE DRAWING

FIG. 1 shows a longitudinal section through the roof and the windshield of a vehicle.

FIG. 2 shows a block diagram for clarifying the coordinate relationships.

FIG. 3 shows a block diagram of a driver assistance system.

### DETAILED DESCRIPTION OF THE INVENTION

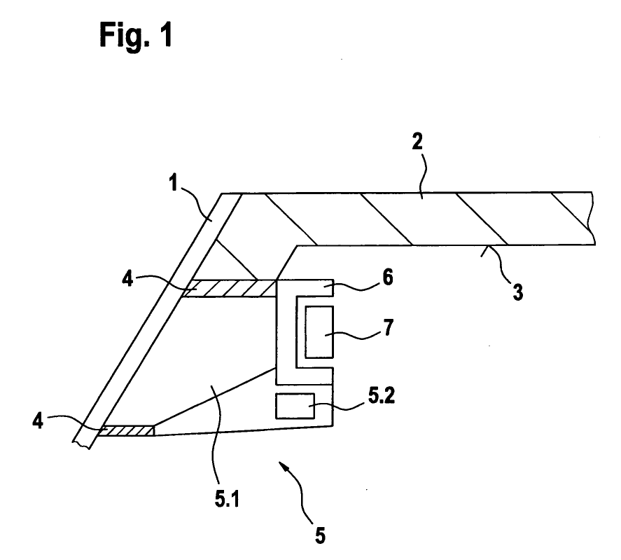

FIG. 1 illustrates a longitudinal section through roof 2 and windshield 1 of a vehicle 10 that is shown only partially in FIG. 1. Roofliner 3 of roof 2 that faces the passenger compartment of vehicle 10 is labeled with reference number 3. The sectional view enables the view of a vehicle adapter 4 disposed on the inner side of windshield 1, which adapter fits snugly against the inner side of windshield 1 and roofliner 3 in a form-fitting manner. Vehicle adapter 4 is thus designed in a vehicle-specific manner and thus enables a simple adjustment to the different slopes of windshields and design of the roofliner of different vehicle types. Vehicle adapter 4 is connected to a universal module 5 that includes a baffle 5.1 and an electronic module 5.2. In interaction with vehicle adapter 4, baffle 5.1 shields the image sensor of the mobile communication device against undesired stray light from the interior of the vehicle and from outside of the measuring range and at the same time limits the visual range of the image sensor. Electronic module 5.2 includes an energy supply device for supplying energy to the mobile communication device, an interface for connecting the mobile communication device to systems of vehicle 10, and possibly control elements that make it possible to control the mobile communication device when it is installed in vehicle 10. Reference number 6 additionally labels a device adapter that accommodates mobile communication device 7 and connects it to universal module 5 in accordance with position and function. This means that device adapter 6 connects mobile communication device 7 mechanically to universal module 5 on the one hand and in the process aligns it such that the image sensor of mobile communication device 7 is aligned toward the detecting range intended for it. On the other hand, device adapter 6 establishes electric connections between mobile communication device 7 and electronic module 5.2 of universal module 5 to enable the supply of energy to mobile communication device 7 from the electrical system of vehicle 10 and a data communication between mobile communication device 7 and systems of vehicle 10.

The above-mentioned structural components having the reference numbers 4, 5, 6 and 7 are connected to one another mechanically and aligned toward one another such that the image sensor of mobile communication device 7 covers the intended detecting range. If required, adjustment means not shown in the drawings, such as adjusting screws and the like, are provided to compensate for mechanical tolerances and to enable the required adjustment. Since mobile communication device 7 must be frequently installed in and removed from device adapter 6, a snap-in connection that is able to be operated even without a tool is advisable in this instance.

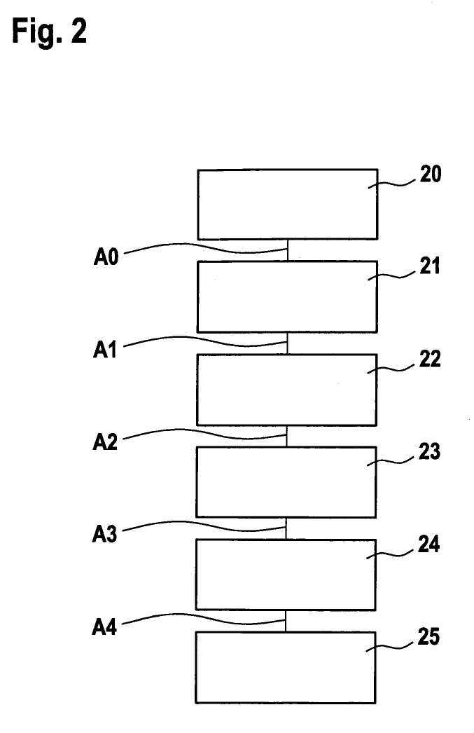

The block diagram shown in FIG. 2 is to clarify the alignment of the image sensor of mobile communication device 7 with the body of vehicle 10. Each of the blocks shown in FIG. 2 represents exemplarily a structural component of vehicle 10 or of the image capturing device for mobile communication device 7. Thus, block 20 represents the body of vehicle 10. Block 21 represents windshield 1 of vehicle 10. Block 22 represents vehicle adapter 4. Block 23 represents universal module 5. Block 24 represents device adapter 6. Finally, block 25 represents the mobile communication device having the image sensor. Operators A0, A1, A2, A3, A4 between the blocks represent transformation rules between the respective local position coordinates relative to a suitable coordinate system, a coordinate system in accordance with DIN 70000, for example. Operator A0 is determined by the position and orientation of windshield 1 relative to the body of vehicle 10. In practice, this means that the vehicle adapter must be designed in a vehicle-specific manner. In the event of very high precision requirements, A1 may be adjusted to the individual vehicle using calibration elements, such as adjusting screws, supporting elements, and the like, in order to compensate for existing tolerances if necessary. This may be performed during the production of vehicle 10 or, for instance, as part of a retrofitting, in a workshop. Operator A2 is constant and predefined by the construction of universal module 5. Operator A3 is adjusted in a device-specific manner. Operator A4 is again constant and predefined by mobile communication device 7. The linking of the operators leads to a total transformation Ages that specifies the alignment of mobile communication device 7 relative to the body of vehicle 10:

Ages=A0*A1*A2*A3*A4

The exact alignment of the image sensor of mobile communication device 7 is determined in essence by device adapter 6 (operator A3). For this reason, contact points or contact surfaces are usefully provided in device adapter 6 that ensure a secure position of mobile communication device 7 and thus an exact alignment of the image sensor of the mobile communication device. After inserting mobile communication device 7 into device adapter 6 and its docking at universal module 5, mobile communication device 7 is prepared for operation in a manner that is fixed to the vehicle.

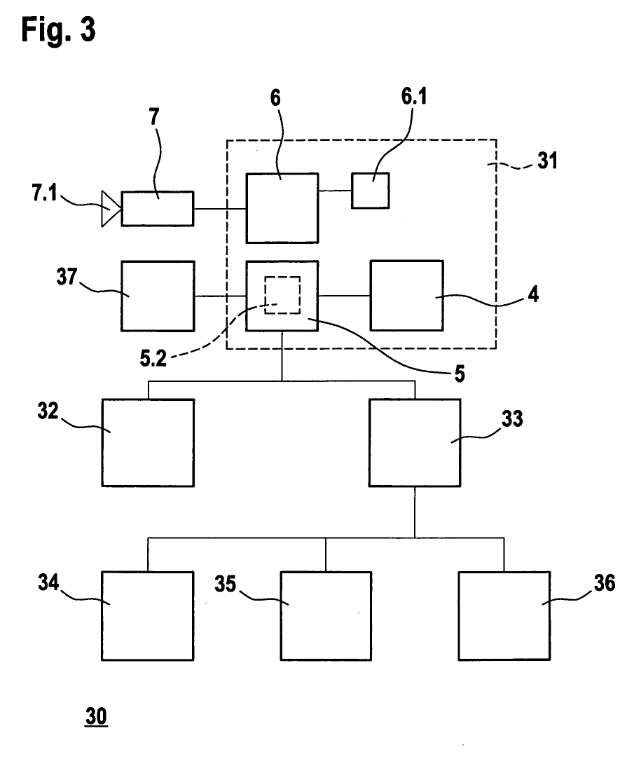

As is clarified with the aid of the block diagram shown in FIG. 3, mobile communication device 7 and its image sensor 7.1 are now integral components of a driver assistance system 30. When the image capturing device is disposed in the position already described above, image sensor 7.1 of mobile communication device 7 may be used as a predictive sensor and enable the detection of road lane markings, for example, in conjunction with a driver assistance function like LDW (Lane Departure Warning). Of course, when the image capturing device is disposed accordingly, other possible uses of image sensor 7.1 are also conceivable. Thus, it may be used as a backward-looking sensor if the image capturing device is disposed in the rear section of vehicle 10. When the image capturing device is disposed in the side region of vehicle 10, image sensor 7.1 may be used as a sideways-looking sensor.

As indicated in FIG. 3 by a corresponding frame, image capturing device 31 includes structural components 4, 5 and 6. Electronic module 5.2 of universal module 5 is connected to electrical system 32 of vehicle 10 and thus enables the supply of energy to the mobile communication device in the installed state. Furthermore, electronic module 5.2 is connected to a control device 33 of driver assistance system 30 that processes the output signals of image sensor 7.1 or variables that have already been derived from them. As a function of the output signals of image sensor 7.1, control device 33 may control a warning device 36 or also steering system 34 of the vehicle, brake system 35, or both systems to enable driver assistance functions like LDW (Lane Departure Warning) or LKS (Lane Keeping System).

If one and the same vehicle is operated for a long time with mobile communication device 7, device adapter 6 may advantageously remain in the vehicle. After the vehicle has been turned off, mobile communication device 7 may be separated from device adapter 6 in a simple way and carried on someone's body. It then once again fulfills its function as a mobile phone (“cell phone” or PDA, that is, personal digital assistant). In the event of a vehicle switch, device adapter 6 is “docked” at the universal module of a holding device present in the new vehicle. It is then possible to continue using mobile communication device 7 in the new vehicle.

Device adapter 6 particularly advantageously includes a memory device in which driver-specific characteristic values are able to be stored and thus are portable, that is, may be introduced into a new vehicle along with the device adapter. In connection with the LDW driver assistance function, these characteristic values may be a driver-specific warning strategy, for example. For this, for example, as part of a warning strategy it is specified whether a warning should be output early, late, or adaptively when a lane is about to be left. Thus, the driver already finds a part of his usual driver assistance functions even in a new vehicle and will value this as particularly comfortable. In the event that mobile communication device 7 is exchanged, a matching device adapter 6 must be procured in some instances.

If holding device 31 is disposed in the region of the interior mirror on the inner side of windshield 1 of vehicle 10, mobile communication device 7, which is held in holding device 31, is subjected to particularly extreme environmental conditions, such as extreme temperature fluctuations, in particular. In the interest of high operational reliability, in particular a cooling is expedient. A passive cooling may be brought about advantageously and particularly cost-effectively by connecting the components of holding device 31, such as vehicle adapter 4, universal module 5, and device adapter 6 well in a heat conducting manner to windshield 1 of vehicle 10. The dissipation heat developing in mobile communication device 7 and in universal module 5 may then be lead off to windshield 1 through a good thermal coupling. In an additional embodiment variant, holding device 31 may include at least one Peltier element for cooling critical components. In an additional embodiment variant, an active cooling may be performed by a fan disposed in universal module 5, which at the same time provides that the lens system of image sensor 7.1 and windshield 1 remain free of condensation at least in the visual range of image sensor 7.1. In an additional embodiment variant, vehicle adapter 4 is connected to the air conditioner of vehicle 10 or to another cooling or heating device. Parts of holding device 31 and the mobile communication device disposed in it may then advantageously be brought to the correct temperature using the air conditioner of the vehicle.

Apart from the already mentioned driver assistance functions like LDW and LKS, the image capturing device may be used advantageously for additional driver assistance functions, such as traffic sign detection, video-based ACC (ACC=Automative Cruise Control) or night vision applications (Night Vision Systems), for example.

1-15. (canceled)

16. An image capturing device for a driver assistance system of a vehicle, wherein the driver assistance system includes a mobile communication device, comprising:
an image sensor incorporated in the mobile communication device; and
a holding device configured to hold the mobile communication device in the vehicle.

17. The image capturing device as recited in claim 16, wherein the holding device includes:
a device adapter configured to accommodate the mobile communication device;
a vehicle adapter fixed to the vehicle; and
a universal module disposed between the vehicle adapter and the device adapter.

18. The image capturing device as recited in claim 17, wherein the vehicle adapter is fixed to the vehicle at a precisely defined position in the vehicle in such a way that the image sensor of the mobile communication device detects images in a predefined detecting range in the surroundings of the vehicle after the device adapter accommodating the mobile communication device has been inserted into the universal module.

19. The image capturing device as recited in claim 18, wherein the universal module includes a baffle configured to keep stray light away from the image sensor of the mobile communication device.

20. The image capturing device as recited in claim 18, wherein the universal module includes an electronic module.

21. The image capturing device as recited in claim 20, wherein the electronic module is connected to an electrical system of the vehicle and enables a supply of energy from the electrical system of the vehicle to the mobile communication device.

22. The image capturing device as recited in claim 20, wherein the electronic module includes a data interface configured for transmission of output signals of the image sensor to at least one system of the vehicle.

23. The image capturing device as recited in claim 20, wherein the electronic module is connected to a control device of the driver assistance system.

24. The image capturing device as recited in claim 20, wherein a cooling device is provided for the mobile communication device.

25. The image capturing device as recited in claim 24, wherein the cooling device is disposed in the universal module.

26. The image capturing device as recited in claim 25, wherein the cooling device includes a fan whose air flow keeps at least one of: a) a subsection of a windshield of the vehicle free of condensation; and b) an optical system of the image sensor free of condensation.

27. The image capturing device as recited in claim 20, wherein the vehicle adapter is connected to an air conditioner of the vehicle in order to enable cooling of components of the image capturing device by the air conditioner.

28. The image capturing device as recited in claim 20, wherein the device adapter includes a first interface configured to be variably adjusted to the mobile communication device and a second interface configured to be adjusted to the universal module.

29. The image capturing device as recited in claim 20, wherein the device adapter includes a memory device.

30. The image capturing device as recited in claim 20, wherein the image sensor incorporated in the mobile communication device is configured as a surround sensor for the driver assistance system of the vehicle.
